(19) United States
(12) Patent Application Publication
(10) Pub. No.: US 2025/0191196 A1
(43) Pub. Date: Jun. 12, 2025

(54) APPARATUS AND METHOD FOR PREDICTING COLLISION BETWEEN EXAMINATION SUBJECT AND IMAGING APPARATUS

(71) Applicant: GE Precision Healthcare LLC, Waukesha, WI (US)

(72) Inventors: Ziyu Liu, Beijing (CN); Feng Li, Beijing (CN); Xinyuan Wang, Beijing (CN)

(21) Appl. No.: 18/972,422

(22) Filed: Dec. 6, 2024

(30) Foreign Application Priority Data
Dec. 8, 2023 (CN) 202311688885.4

(51) Int. Cl. G06T 7/20; G06T 7/12; G06T 7/50; G06V 10/44; G06V 10/46

(52) U.S. Cl. CPC G06T 7/20; G06T 7/12; G06T 7/50; G06V 10/44; G06V 10/469

(57) ABSTRACT

The present invention relates to a method for predicting a collision between an examination subject and an imaging apparatus, and an imaging apparatus. The prediction method may include: acquiring an image package of the examination subject via a multi-modal camera system, the image package including a depth image and a thermal image of the examination subject, and the multi-modal camera system including a depth camera module and a thermal camera module; acquiring a 2D contour of the examination subject based on segmentation processing performed on the thermal image; generating a 3D contour of the examination subject based on the 2D contour of the examination subject and the depth image of the examination subject; and estimating, based on the 3D contour of the examination subject, whether the examination subject will collide, on a movement path thereof, with an imaging apparatus scanning the examination subject. The imaging apparatus provided in the present invention can achieve the same prediction effect.

### CROSS-REFERENCE TO RELATED APPLICATIONS

This application claims priority to Chinese Application No. 202311688885.4, filed on Dec. 8, 2023, the disclosure of which is incorporated herein by reference in its entirety.

### TECHNICAL FIELD

The present invention relates generally to the medical field, and more particularly to an apparatus and method for predicting a collision between an examination subject and an imaging apparatus.

### BACKGROUND

In medical institutions, it is often necessary to use imaging apparatuses, such as computed tomography (CT), nuclear magnetic resonance (MR), etc., to scan and image examination subjects such as human bodies, animal bodies, etc. In this process, when an operator controls movement of a scanning table or the scanning table adjusts movement automatically, there is a high possibility that the examination subject collides with a scanning machine frame. For example, as shown in FIG. 16, the elbow joint of the human body being examined, if held still, will collide with the scanning machine frame. In order to avoid the occurrence of such a collision accident, it is desirable to predict such a collision.

In practice, in addition to sites (e.g., the elbow joint, the leg, the head, etc., of the human body) on the examination subject, areas that may possibly collide with the scanning machine frame may further be accessories on the scanning table such as a sheet, a blanket, etc., and may also be, e.g., “noise” of an operator or the like standing very close to the examination subject. However, even if the accessories on the scanning table are subjected to a collision, the scanning is not affected, and the examination subject is not harmed. The operator does not enter a scanning machine frame hole along with the scanning table, and therefore does not collide with the scanning machine frame. Interference factors such as the above accessories and “noise” greatly affect the accuracy of predicting whether the examination subject will collide with the imaging apparatus.

Therefore, there is a high necessity for a technique capable of accurately predicting a collision between an examination subject and an imaging apparatus while excluding other interference factors.

### SUMMARY

The present invention aims to overcome the above and/or other problems in the prior art. According to the present invention, provided are a method for predicting a collision between an examination subject and an imaging apparatus, and an imaging apparatus capable of implementing such a prediction, which can predict with high accuracy whether an examination subject will collide with an imaging apparatus while completely excluding interference factors such as accessories and “noise”, thereby effectively ensuring that the imaging apparatus scans and images the examination subject efficiently and safely.

According to a first aspect of the present invention, provided is a method for predicting a collision between an examination subject and an imaging apparatus, which may include acquiring an image package of the examination subject via a multi-modal camera system, where the image package including a depth image and a thermal image of the examination subject, and the multi-modal camera system including a depth camera module and a thermal camera module; acquiring a 2D contour of the examination subject based on segmentation processing performed on the thermal image; generating a 3D contour of the examination subject based on the 2D contour of the examination subject and the depth image of the examination subject; and estimating, based on the 3D contour of the examination subject, whether the examination subject will collide, on a movement path thereof, with an imaging apparatus scanning the examination subject.

According to a second aspect of the present invention, an example imaging apparatus may include a machine frame, a multi-modal camera system, and a processing unit. The machine frame may include a machine frame hole for accommodating an examination subject. The multi-modal camera system may include a depth camera module and a thermal camera module. The multi-modal camera system may be configured to acquire an image package of the examination subject. The image package may include a depth image and a thermal image of the examination subject. The multi-modal camera system may include a depth camera module and a thermal camera module. The processing unit may be configured to acquire a 2D contour of the examination subject based on segmentation processing performed on the thermal image, generate a 3D contour of the examination subject based on the 2D contour of the examination subject and the depth image of the examination subject, and estimate, based on the 3D contour of the examination subject, whether the examination subject will collide, on a movement path thereof, with an imaging apparatus scanning the examination subject.

In the present invention, the 2D contour of the examination subject is innovatively acquired via the segmentation processing performed on the thermal image, and depth information is further used, so that other interference factors not belonging to the examination subject can be excluded from the acquired 2D contour based on thermal temperature information. On that basis, in combination with depth information of the examination subject, the 3D contour more comprehensively and more accurately reflecting the position and posture of the examination subject can be acquired, thereby more accurately predicting whether the examination subject will collide with the imaging apparatus.

The method may further include performing the segmentation processing on the thermal image based on a plurality of predetermined temperature thresholds to acquire a plurality of thermal contour images; and extracting the 2D contour of the examination subject from a thermal contour image most conforming to a contour of the examination subject among the plurality of thermal contour images. Accordingly, the above processing unit may be further configured to perform the segmentation processing on the thermal image based on a plurality of predetermined temperature thresholds to acquire a plurality of thermal contour images, and extract the 2D contour of the examination subject from a thermal contour image most conforming to a contour of the examination subject among the plurality of thermal contour images.

In the above implementation manner, the thermal contour image most conforming to the examination subject is found among the plurality of thermal contour images acquired by performing the temperature threshold-based segmentation processing, and the 2D contour of the examination subject is extracted therefrom. The temperature threshold corresponding to the thermal contour image most conforming to the examination subject is closest to the temperature of the examination subject sensed by the thermal camera module.

Alternatively, the image package of the examination subject may be acquired via the multi-modal camera system in real time, and the method may include performing segmentation processing on a current thermal image based on a preselected temperature threshold to acquire a thermal contour image, and extracting the 2D contour of the examination subject from the thermal contour image. Accordingly, the above processing unit may be further configured to perform segmentation processing on a current thermal image based on a preselected temperature threshold to acquire a thermal contour image, and extract the 2D contour of the examination subject from the thermal contour image.

If the temperature of the examination subject sensed by the thermal camera module can be determined, the temperature may be directly used to perform temperature threshold-based segmentation processing on the thermal image acquired in real time, to directly acquire the thermal contour image corresponding to the examination subject and extract the 2D contour of the examination subject therefrom.

The above temperature threshold corresponding to the temperature of the examination subject sensed by the thermal camera module may be acquired in a plurality of manners. For example, the temperature threshold may be acquired via the following steps: performing, based on a plurality of predetermined temperature thresholds, segmentation processing on a thermal image acquired at a certain previous time to acquire a plurality of thermal contour images; and selecting, from the plurality of thermal contour images, a thermal contour image most conforming to a contour of the examination subject, and determining a temperature threshold corresponding thereto to be the preselected temperature threshold. Accordingly, the above processing unit may be further configured to perform, based on a plurality of predetermined temperature thresholds, segmentation processing on a thermal image acquired at a certain previous time to acquire a plurality of thermal contour images, and select, from the plurality of thermal contour images, a thermal contour image most conforming to a contour of the examination subject, and determine a temperature threshold corresponding thereto to be the preselected temperature threshold.

The above thermal contour image most conforming to the contour of the examination subject may be acquired in a plurality of manners. For example, the thermal contour image most conforming to the contour of the examination subject may be selected via comparison with an a priori template image acquired in advance, wherein the a priori template image may be acquired via the following steps: acquiring in advance a plurality of thermal images of different examination subjects under different conditions; performing segmentation processing on each of the plurality of thermal images separately based on a plurality of predetermined temperature thresholds to acquire a plurality of a priori thermal contour images, and selecting, from the plurality of a priori thermal contour images, an optimal thermal contour image most conforming to a contour of the examination subject; and extracting features from all the optimal thermal contour images corresponding to the plurality of thermal images, and creating the a priori template image based on the extracted features. Accordingly, the above processing unit may be further configured to acquire in advance a plurality of thermal images of different examination subjects under different conditions, perform segmentation processing on each of the plurality of thermal images separately based on a plurality of predetermined temperature thresholds to acquire a plurality of a priori thermal contour images, and select, from the plurality of a priori thermal contour images, an optimal thermal contour image most conforming to a contour of the examination subject, and extract features from all the optimal thermal contour images corresponding to the plurality of thermal images, and create the a priori template image based on the extracted features.

The above comparison with the a priori template image acquired in advance may including, for example, comparing features in the plurality of thermal contour images with features in the a priori template image to acquire the thermal contour image most conforming to the contour of the examination subject. Accordingly, the above processing unit may be further configured to: acquire the thermal contour image most conforming to the contour of the examination subject by comparing features in the plurality of thermal contour images with features in the a priori template image.

The method may further include calculating 3D coordinate values of each point on the examination subject based on depth information in the depth image and pixel distance information in the 2D contour, and acquiring the 3D contour based on all the 3D coordinate values. Accordingly, the above processing unit may be further configured to calculate 3D coordinate values of each point on the examination subject based on depth information in the depth image and pixel distance information in the 2D contour, and acquire the 3D contour based on all the 3D coordinate values.

The above depth information includes a perpendicular depth from each point on the examination subject to a focal point of the depth camera module or the thermal camera module. The above pixel distance information includes a pixel distance from each pixel in the 2D contour to the focal point of the depth camera module or the thermal camera module. The pixels in the 2D contour correspond to the points on the examination subject.

The thermal image or the 2D contour may be converted to be in a depth camera coordinate system, or the depth image may be converted to be in a thermal camera coordinate system. Accordingly, the above processing unit may be further configured to: converting the thermal image or the 2D contour to be in a depth camera coordinate system, or converting the depth image to be in a thermal camera coordinate system.

Via a thermal image conversion matrix, the thermal image or the 2D contour may be converted to be in the depth camera coordinate system, or the depth image may be converted to be in the thermal camera coordinate system.

The thermal image conversion matrix may be acquired via the following steps: positioning a calibration tool so that the calibration tool is in both a field of view of a depth camera and a field of view of a thermal camera; imaging the calibration tool via the depth camera and the thermal camera respectively, and calculating depth image interior angle coordinate values of an interior angle on the calibration tool in the depth camera coordinate system and thermal image interior angle coordinate values of the interior angle on the calibration tool in the thermal camera coordinate system, wherein the calibration tool is heated to generate a thermal difference from an original temperature thereof; and calculating the thermal image conversion matrix based on the depth image interior angle coordinate values and the thermal image interior angle coordinate values.

The calibration tool may be provided with a plurality of rows of regularly arranged rectangular holes, so that after the calibration tool is heated, interior angle coordinates of the rectangular holes can be read from the thermal image acquired by the thermal camera module.

The method may further include calculating 3D contour coordinate values of the 3D contour of the examination subject in a machine frame coordinate system of the imaging apparatus, the 3D contour coordinate values including 3D contour coordinate values of the examination subject moving to each position during scanning; and when the 3D contour coordinate values overlap with coordinate values of a machine frame hole of the imaging apparatus, determining that the examination subject will collide, on the movement path thereof, with the machine frame hole. Accordingly, the above processing unit may be further configured to: calculate 3D contour coordinate values of the 3D contour of the examination subject in a machine frame coordinate system of the imaging apparatus, the 3D contour coordinate values including 3D contour coordinate values of the examination subject moving to each position during scanning; and when the 3D contour coordinate values overlap with coordinate values of a machine frame hole of the imaging apparatus, determine that the examination subject will collide, on the movement path thereof, with the machine frame hole.

According to a third aspect of the present invention, provided is a computer-readable storage medium, having coded instructions recorded thereon, wherein when the instructions are executed, the method for predicting a collision between an examination subject and an imaging apparatus according to the present invention described above can be implemented.

Other features and aspects of the present invention will become clearer via the detailed description provided below with reference to the accompanying drawings.

### BRIEF DESCRIPTION OF THE DRAWINGS

The present invention can be better understood by means of the description of the exemplary embodiments of the present invention in conjunction with the drawings, in which:

FIG. 1 shows a flowchart of a method for predicting a collision between an examination subject and an imaging apparatus according to an embodiment of the present invention;

FIG. 2 is a schematic diagram of imaging an examination subject according to an embodiment of the present invention;

FIG. 3 is a schematic diagram of processing each image according to an embodiment of the present invention;

FIG. 4 is a flowchart of an embodiment of the prediction method shown in FIG. 1;

FIG. 5 shows a schematic diagram of performing temperature threshold-based segmentation processing on a thermal image according to an embodiment of the present invention;

FIG. 6 is a flowchart of another embodiment of the prediction method shown in FIG. 1;

FIG. 7 is an exemplary schematic diagram of acquiring an a priori template image according to an embodiment of the present invention;

FIG. 8(a) shows a schematic diagram of acquiring a 2D image of an object;

FIG. 8(b) schematically shows a corresponding geometric relationship between relevant parameters in FIG. 8(a);

FIG. 9 exemplarily shows how to acquire a thermal image conversion matrix;

FIG. 10 exemplarily shows how to acquire a depth image-RGB image conversion matrix;

FIG. 11 is a flowchart of still another embodiment of the prediction method shown in FIG. 1;

FIG. 12 exemplarily shows how to acquire a machine frame-multi-modal camera conversion matrix;

FIG. 13 schematically shows a path on which an examination subject moves along with a scanning table during scanning;

FIG. 14 schematically shows different cases in which a collision will occur and in which no collision will occur;

FIG. 15 shows a schematic diagram of an imaging apparatus according to an embodiment of the present invention; and

FIG. 16 shows a schematic diagram showing that an examination subject may collide with an imaging apparatus.

### DETAILED DESCRIPTION

The present invention will be further described below with reference to specific embodiments and the accompanying drawings. More details are set forth in the following description in order to facilitate thorough understanding of the present invention, but it will be apparent that the present invention can be implemented in many other manners other than those described herein, and those skilled in the art can, without departing from the spirit of the present invention, make similar alterations and modifications according to practical applications. Therefore, the scope of protection of the present invention should not be limited by the contents of the specific embodiments.

Unless defined otherwise, technical terms or scientific terms used in the claims and description should have the usual meanings that are understood by those of ordinary skill in the technical field to which the present invention belongs. Terms such as “first”, “second”, and similar terms used in the description and claims of the present application do not denote any order, quantity, or importance, but are only intended to distinguish different constituents. The terms “one” or “a/an” and similar terms do not express a limitation of quantity, but rather that at least one is present. The terms “include” or “comprise” and similar words indicate that an element or object preceding the terms “include” or “comprise” encompasses elements or objects and equivalent elements thereof listed after the terms “include” or “comprise”, and do not exclude other elements or objects. The terms “connect” or “link” and similar words are not limited to physical or mechanical connections, and are not limited to direct or indirect connections.

According to an embodiment of the present invention, provided is a method for predicting a collision between an examination subject and an imaging apparatus.

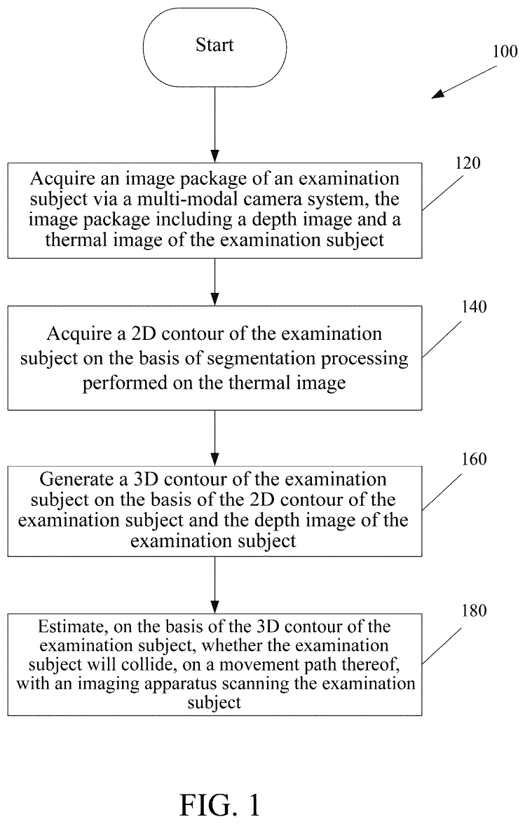

FIG. 1 shows a flowchart of a method 100 for predicting a collision between an examination subject and an imaging apparatus according to an embodiment of the present invention. As shown in FIG. 1, the method 100 may include step 120 to step 180.

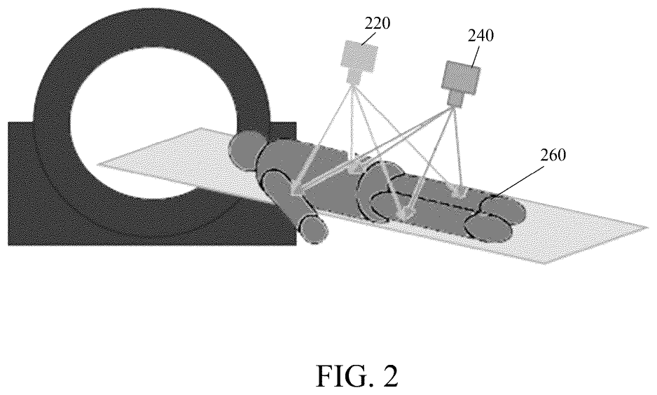

In step 120, an image package of an examination subject may be acquired via a multi-modal camera system. As shown in FIG. 2, the multi-modal camera system may include a depth camera module 220 and a thermal camera module 240 configured to respectively acquire a depth image and a thermal image of the examination subject 260 in the image package.

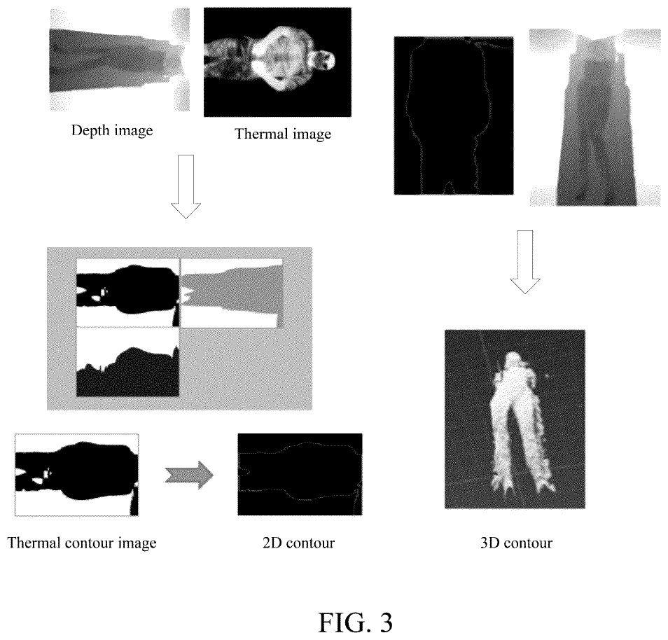

In step 140, a 2D contour of the examination subject may be acquired based on segmentation processing performed on the thermal image. The degree of brightness of each pixel in the thermal image represents a temperature level of the object corresponding to the pixel. Pixels below a certain temperature threshold can be excluded by performing the segmentation processing on the thermal image. As shown in FIG. 3, after the segmentation processing is performed on the thermal image, a thermal contour image of the examination subject may be acquired. Grayscale information in the thermal contour image represents only parts of the examination subject. In other words, other interference factors that are not parts of the examination subject have been excluded. The 2D contour of the examination subject can be clearly extracted from the thermal contour image.

Next, in step 160, as shown in FIG. 3, a 3D contour of the examination subject may be generated based on the 2D contour of the examination subject and the depth image of the examination subject. The 3D contour can more comprehensively and more accurately reflect the position and posture of the examination subject, thereby facilitating more accurate collision estimation performed subsequently.

Finally, in step 180, whether the examination subject will collide, on a movement path thereof, with an imaging apparatus scanning the examination subject may be estimated based on the 3D contour of the examination subject. 3D coordinate values of the imaging apparatus are known. For example, if the imaging apparatus is a CT machine, 3D coordinate values of a machine frame hole thereof may be directly acquired from a CT scanning system. Therefore, whether the examination subject will collide with the machine frame hole may be determined based on the 3D contour of the examination subject and the 3D coordinate values of the machine frame hole.

Compared with the prior art in which it is detected whether each object on/near a scanning table will collide with a scanning and imaging apparatus, the segmentation processing of the thermal image is ingeniously introduced to the present invention, so that all interference factors not belonging to the examination subject are excluded from the acquired 2D contour, and are therefore also excluded from a range in which it is necessary to estimate whether a collision will occur, thereby greatly improving the efficiency and accuracy of collision prediction. Depth information of the examination subject is further particularly introduced to the collision prediction method of the present invention, and the 3D contour acquired on that basis in combination with the 2D contour of the examination subject can more comprehensively and more accurately reflect the position and posture of the examination subject, thereby further improving the accuracy of collision prediction.

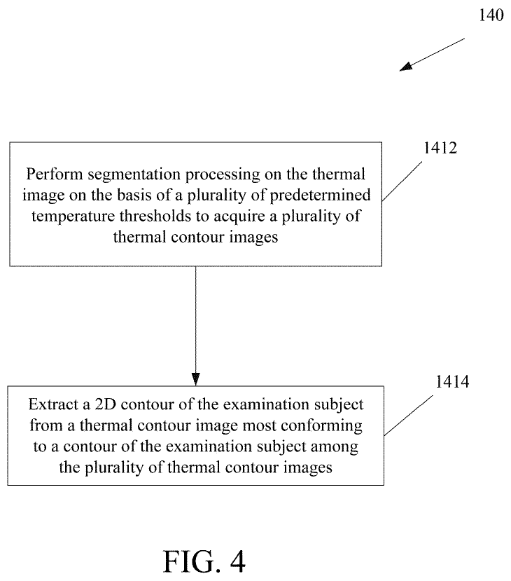

Optionally, step 140 may include sub-steps 1412 and 1414 as shown in FIG. 4.

In sub-step 1412, the segmentation processing may be performed on the thermal image based on a plurality of predetermined temperature thresholds to acquire a plurality of thermal contour images. Performing the segmentation processing on the thermal image based on a certain temperature threshold means that object information corresponding to temperatures below the temperature threshold is excluded, and the acquired thermal contour image no longer includes grayscale information of objects corresponding to the temperatures below the temperature threshold. The plurality of predetermined temperature thresholds may be determined according to an ambient temperature in combination with an actual condition of the examination subject. For example, a temperature range may be determined first, and then a plurality of temperature thresholds may be selected from the temperature range.

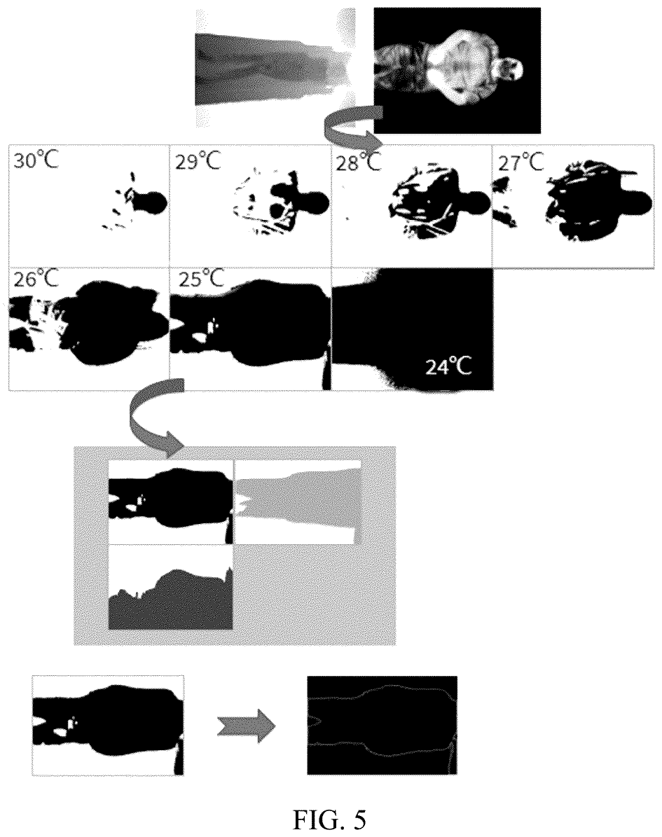

For example, as shown in FIG. 5, the examination subject is a human body, and the human body temperature is generally lower than or equal to 38° C., which is an empirical value of the average human body temperature. After measurement is performed by the thermal camera module at different room temperatures, it can be determined that the temperature range of the human body sensed by the thermal camera module is 24° C. to 30° C., and temperatures, which can be sensed by the thermal camera module, of other objects that are not parts of the human body are necessarily below the temperature range. A plurality of corresponding thermal contour images may be acquired by performing the segmentation processing on the thermal image based on temperature thresholds 24° C., 25° C., 26° C., 27° C., 28° C., 29° C., and 30° C. selected from the temperature range, and these thermal contour images contain only grayscale information corresponding to parts of the human body.

Next, in sub-step 1414, the 2D contour of the examination subject may be extracted from a thermal contour image most conforming to a contour of the examination subject among the plurality of thermal contour images.

Still using FIG. 5 as an example, in the plurality of acquired thermal contour images, human body contours in the thermal contour images acquired by performing the threshold-based segmentation processing based on 26° C., 27° C., 28° C., 29° C., and 30° C. have missing parts at varying degrees. However, the contour in the thermal contour image acquired by performing the threshold-based segmentation processing based on 24° C. has no missing part, but is merely an enlarged part of the human body. In contrast, only the contour in the thermal contour image acquired by performing the threshold based segmentation processing based on 25° C. not only is complete, but also can substantially reflect the main contour of the human body, and can be used as the thermal contour image most conforming to the contour of the human body, and the 2D contour of the human body can be extracted from the thermal contour image.

Optionally, in step 120, the multi-modal camera system may acquire the image package of the examination subject in real time.

If the temperature of the examination subject sensed by the thermal camera module is unknown, the thermal contour image most conforming to the examination subject may be found in the implementation manner shown in FIG. 4, and the temperature threshold corresponding to the thermal contour image is closest to the temperature of the examination subject sensed by the thermal camera module. However, if the temperature of the examination subject sensed by the thermal camera module can be determined, particularly when the multi-modal camera system acquires the image package of the examination subject in real time to perform collision prediction, the temperature of the examination subject sensed by the thermal camera module may be directly used to perform the temperature threshold based segmentation processing on the thermal image acquired in real time.

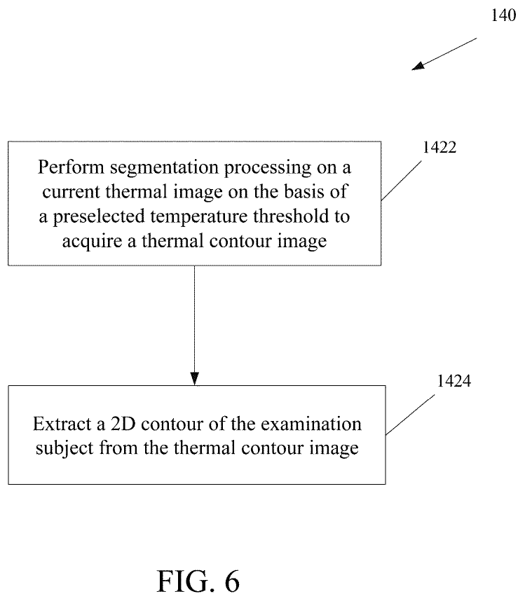

Optionally, step 140 may include sub-steps 1422 and 1424 as shown in FIG. 6.

In sub-step 1422, segmentation processing may be performed on a current thermal image based on a preselected temperature threshold to acquire a thermal contour image.

In sub-step 1424, the 2D contour of the examination subject may be extracted from the thermal contour image.

Still taking human body examination as an example, when it is determined that the temperature of the human body sensed by the thermal camera module is 25° C., the segmentation processing may be performed on the current thermal image directly based on the temperature threshold of 25° C. Grayscale information of other interference factors that are not parts of the human body are also necessarily excluded from the acquired thermal contour image, and the acquired thermal contour image contains only grayscale information corresponding to parts of the human body. A 2D contour of the human body can be extracted from the thermal contour image.

The above preselected temperature threshold may be acquired in a plurality of manners. For example, as described in sub-step 1412, segmentation processing may be performed, based on a plurality of predetermined temperature thresholds, on a thermal image acquired at a certain previous time to acquire a plurality of thermal contour images, and then as described in sub-step 1414, a thermal contour image most conforming to a contour of the examination subject may be selected from the plurality of thermal contour images. Finally, the temperature threshold corresponding to the thermal contour image most conforming to the contour of the examination subject may be determined to be the preselected temperature threshold.

Still taking the human body examination in FIG. 5 as an example, after segmentation processing is performed, based on the temperature thresholds 24° C., 25° C., 26° C., 27° C., 28° C., 29° C., and 30° C., on a thermal image acquired at a certain time, a thermal contour image acquired by performing the segmentation processing on the thermal image based on 25° C. is selected therefrom, and most conforms to the human body contour, and 25° C. may be determined to be the preselected temperature threshold, i.e., the temperature of the human body sensed by the thermal camera module. Threshold based segmentation processing can be performed, directly based on 25° C., on all thermal images of the human body acquired subsequently in real time, and a 2D contour of the human body can be extracted from a thermal contour image resulting from the threshold-based segmentation processing.

Optionally, the thermal contour image most conforming to the contour of the examination subject may be selected via comparison with an a priori template image acquired in advance.

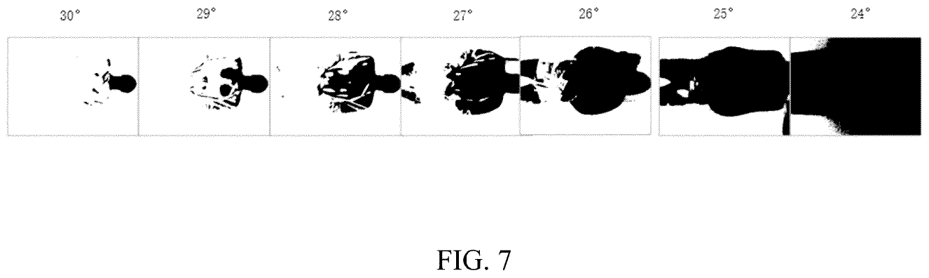

Still taking human body examination as an example, in order to acquire an a priori template image of a human body, a plurality of thermal images of different human bodies may be acquired under different conditions in advance, and then segmentation processing may be performed on each one of these thermal images based on a plurality of predetermined temperature thresholds. FIG. 7 shows a plurality of a priori thermal contour images acquired after performing segmentation processing on a thermal image based on a plurality of predetermined temperature thresholds. Likewise, the plurality of predetermined temperature thresholds may be selected according to an ambient temperature in combination with the normal human body temperature. An optimal thermal contour image most conforming to the human body contour is selected from the plurality of a priori thermal contour images. For example, among seven a priori thermal contour images, shown in FIG. 7, acquired by performing threshold based segmentation processing based on 24° C., 25° C., 26° C., 27° C., 28° C., 29° C., and 30° C., the thermal contour image acquired after performing the threshold based segmentation processing based on 25° C. relatively most completely reflects the main contour of the human body, and this thermal contour image is selected as an optimal thermal contour image most conforming to the human body contour. All thermal images are processed in the same manner to acquire a plurality of optimal thermal contour images. Features are extracted from all these optimal thermal contour images, and the a priori template image of the human body may be created based on these extracted features. The extracted features may include an area, a length-width ratio, a horizontal or vertical projection, etc. After the segmentation processing is performed on the thermal image of the human body based on the plurality of temperature thresholds, each thermal image of the human body acquired from the segmentation processing may be directly compared with the above a priori template image, and a closest comparison result may be found, which is the thermal contour image most conforming to the human body contour.

Optionally, during comparison with the a priori template image acquired in advance, features in the plurality of thermal contour images may be compared with features in the a priori template image to acquire the thermal contour image most conforming to the contour of the examination subject.

Still taking the human body examination in FIG. 5 as an example, after segmentation processing is performed on the acquired thermal image based on the temperature thresholds 24° C., 25° C., 26° C., 27° C., 28° C., 29° C., and 30° C., contour areas in these thermal contour images acquired from the segmentation processing may each be compared with a contour area in the a priori template image of the human body to find the closest one, and the thermal contour image thereof is the thermal contour image most conforming to the human body contour. Alternatively, length-width ratios in these thermal contour images acquired from the segmentation processing may each be compared with a length-width ratio in the a priori template image of the human body to find the closest one, and the thermal contour image thereof is the thermal contour image most conforming to the human body contour. Alternatively, horizontal/vertical projections in these thermal contour images acquired from the segmentation processing may each be compared with a horizontal/vertical projection in the a priori template image of the human body to find the closest one, and the thermal contour image thereof is the thermal contour image most conforming to the human body contour.

Optionally, step 160 may include: calculating 3D coordinate values of each point on the examination subject based on depth information in the depth image and pixel distance information in the 2D contour, and acquiring the 3D contour based on all the 3D coordinate values.

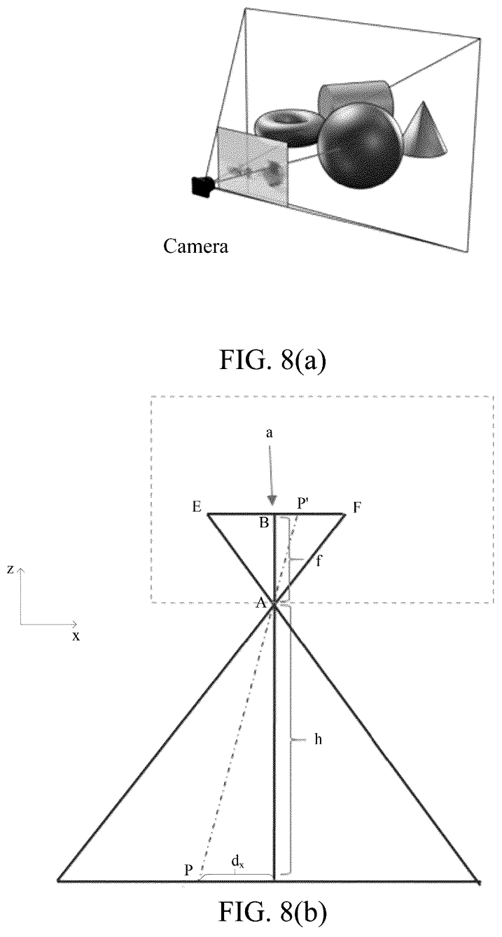

FIG. 8(a) shows a schematic diagram of using a camera to acquire a 2D image of an object. In order to acquire a 3D contour of an object, it is necessary to learn 3D coordinate values of each point on the object, that is, 3D coordinate values (x, y, z) of each point in FIG. 8(a) with respect to the center of the camera (i.e., a focal point of the camera). FIG. 8(b) schematically shows a corresponding geometric relationship between relevant parameters in FIG. 8(a). In FIG. 8(b), a straight line a corresponds to the focal point of the camera, and the length of the line segment AB corresponds to a focal length f of the camera, which are inherent in the camera and are known. For a point P in FIG. 8(b), depth information thereof in a depth image corresponds to a perpendicular depth h from the point P to the focal point of the camera, that is, z in the above 3D coordinate values. x and y in the 3D coordinate values are perpendicular distances dₓ and d_{y} from the point P to the focal point of the camera in the other two directions (i.e., the X direction in the drawing and the Y direction perpendicular to the X-Z plane). A line segment EF in FIG. 8(b) corresponds to a 2D image (a 2D contour) of the object. P′ on EF may reflect 2D pixel distance information of the point P, including a pixel distance (BP′) from the point P′ to the focal point of the camera in the X direction and a pixel distance (not shown in FIG. 8(b)) from the point P′ to the focal point of the camera in the Y direction. As can be seen from the geometric relationship in the drawing, f/h=BP′/dₓ. Therefore, dₓ, i.e., x in the 3D coordinate values, can be calculated. It can be understood that for clarity of illustration, FIG. 8(b) is merely a schematic diagram of the X-Z plane. Similarly, in the schematic diagram of the X-Z plane, d_{y}, i.e., y in the 3D coordinate values, may be calculated in the same manner.

The camera involved in the above calculation may be any camera. If the camera is a depth camera, both the depth information in the depth image and the 2D pixel distance information in the 2D image need to be converted to be in a depth camera coordinate system. If the camera is a thermal camera, both the depth information in the depth image and the 2D pixel distance information in the 2D image need to be converted to be in a thermal camera coordinate system. In summary, both the depth information in the depth image and the 2D pixel distance information in the 2D image need to be converted to be in the same camera coordinate system.

Returning to step 160, since the depth image and the thermal image are respectively acquired by the depth camera module and the thermal camera module, the thermal image or the 2D contour acquired based on the thermal image may be converted to be in the depth camera coordinate system, and 3D coordinate values of each point on the examination subject may be calculated based on the depth information (the perpendicular depth from each point on the examination subject to the focal point of the depth camera module) and the pixel distance information in the 2D contour (the pixel distance from each pixel in the 2D contour to the focal point of the depth camera module) in combination with the focal length of the depth camera. Alternatively, the depth image may be converted to be in the thermal camera coordinate system, and 3D coordinate values of each point on the examination subject may also be calculated based on the depth information (the perpendicular depth from each point on the examination subject to the focal point of the thermal camera module) and the pixel distance information in the 2D contour (the pixel distance from each pixel in the 2D contour to the focal point of the thermal camera module) in combination with the focal length of the thermal camera. The pixels in the above 2D contour correspond to the points on the examination subject.

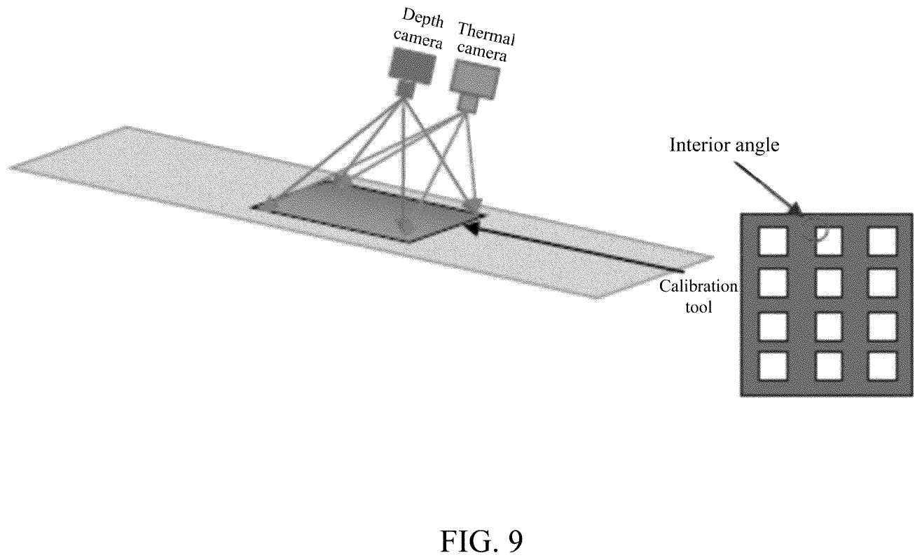

Optionally, via a thermal image conversion matrix, the thermal image or the 2D contour may be converted to be in the depth camera coordinate system, or the depth image may be converted to be in the thermal camera coordinate system. How to acquire the thermal image conversion matrix will be exemplified below with reference to FIG. 9.

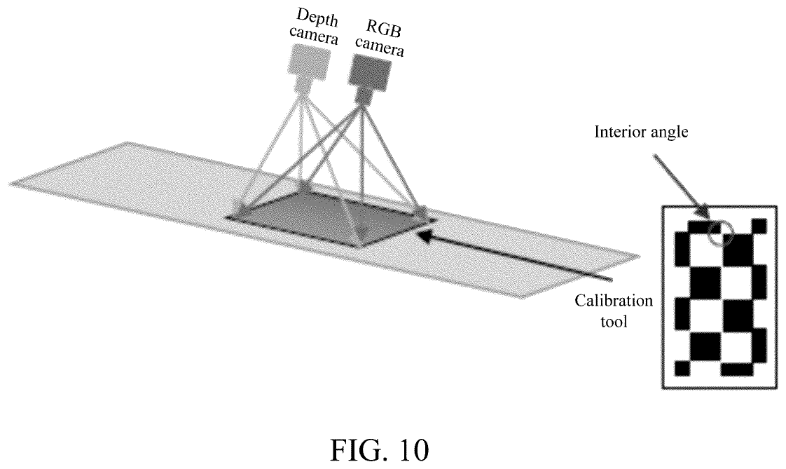

As shown in FIG. 9, a calibration tool is first positioned, and may be positioned, for example, on a scanning table, as long as the calibration tool is located in both a field of view of the depth camera and a field of view of the thermal camera. With respect to the calibration tool, if a checkerboard-like calibration tool (a flat board having black and white squares of a checkerboard) shown in FIG. 10 is used, it is impossible to determine coordinates of each interior angle in a thermal image of the black and white squares, so that for acquisition of a thermal image conversion matrix between a thermal camera coordinate system and another camera coordinate system, a calibration tool with holes is specifically designed in the present invention, and is as shown in FIG. 9. The calibration tool with holes is a flat board, and the flat board is provided with a plurality of rows of regularly arranged rectangular holes, so that after the calibration tool is heated, a thermal difference is generated between rectangular cut-out portions and the remaining non-cut-out portions, and interior angle coordinates of the rectangular holes can therefore be clearly read from an acquired thermal image.

After the calibration tool is positioned as shown in FIG. 9, the calibration tool may be imaged by the depth camera and the thermal camera respectively. The size of an acquired image may be adjusted via, for example, interpolation and padding.

Next, depth image interior angle coordinate values of an interior angle on the calibration tool in the depth camera coordinate system and thermal image interior angle coordinate values of the interior angle on the calibration tool in the thermal camera coordinate system may be calculated. In order to acquire a thermal image, the calibration tool needs to be heated, so that the temperature thereof rises, and a thermal difference from an original temperature is generated. The depth image interior angle coordinate values are interior angle coordinate values of each rectangular hole on the calibration tool in an acquired depth image, and the thermal image interior angle coordinate values are interior angle coordinate values of each rectangular hole on the calibration tool in an acquired thermal image. All interior angle coordinate values in the depth image and the thermal image may be found, for example, by searching for interior angle scores of the rectangular holes in the depth image and the thermal image respectively.

Finally, the thermal image conversion matrix is calculated based on the depth image interior angle coordinate values and the thermal image interior angle coordinate values. A conversion matrix H for coordinate value conversion between the depth camera coordinate system and the thermal camera coordinate system may be calculated by using, for example, a homography algorithm.

Optionally, an RGB camera module may further be introduced to the multi-modal camera system used in the present invention to additionally acquire an RGB image of the examination subject, and both the thermal image or the 2D contour acquired based on the thermal image and the depth image may be converted to be in an RGB camera coordinate system. In this way, a user can perform more intuitive monitoring in the above collision prediction method, and can directly perform operations such as stopping scanning as necessary.

The thermal image or the 2D contour acquired based on the thermal image may be converted to be in the RGB camera coordinate system via a thermal image-RGB image conversion matrix. Acquisition of the thermal image-RGB image conversion matrix is similar to the above acquisition of the thermal image conversion matrix, except the depth camera in the thermal image conversion matrix acquisition process is replaced with the RGB camera. RGB image interior angle coordinate values of the interior angles on the calibration tool in the RGB camera coordinate system are calculated, and finally the thermal image-RGB image conversion matrix is calculated based on the RGB image interior angle coordinate values and the thermal image interior angle coordinate values.

The depth image may be converted to be in the RGB camera coordinate system via a depth image-RGB image conversion matrix. Acquisition of the depth image-RGB image conversion matrix is similar to the above acquisition of the thermal image conversion matrix, except the thermal camera in the thermal image conversion matrix acquisition process is replaced with the RGB camera. RGB image interior angle coordinate values of the interior angles on the calibration tool in the RGB camera coordinate system are calculated, and finally the depth image-RGB image conversion matrix is calculated based on the RGB image interior angle coordinate values and the depth image interior angle coordinate values. Since it is not necessary to acquire a thermal image in the process of acquiring the depth image-RGB image conversion matrix, it is not necessary to heat the calibration tool, and the calibration tool used may still be a flat board provided with a plurality of rows of regularly arranged rectangular holes as described above, or may be a checkerboard-like calibration tool. As shown in FIG. 10, if a checkerboard-like calibration tool is used, the interior angle is the interior angle of each black or white square on the checkerboard-like calibration tool.

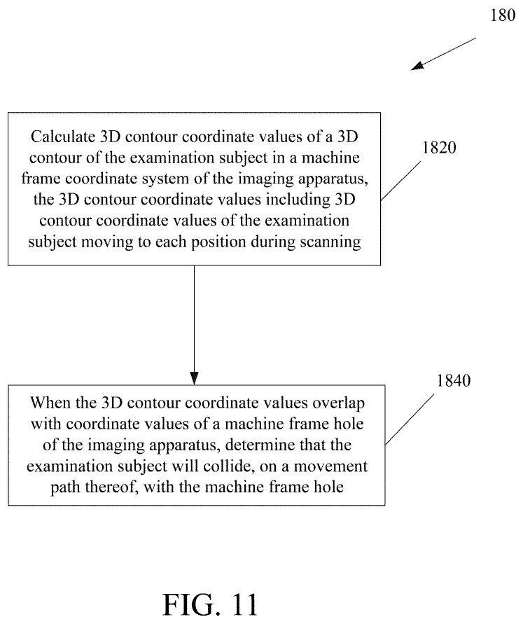

Optionally, step 180 may include sub-steps 1820 and 1840 as shown in FIG. 11.

In sub-step 1820, 3D contour coordinate values of the 3D contour of the examination subject in a machine frame coordinate system of the imaging apparatus may be calculated, the 3D contour coordinate values including 3D contour coordinate values of the examination subject moving to each position during scanning. That is, the 3D contour coordinate values include not only the current position of the examination subject in the machine frame coordinate system, but also the position of the examination subject in the machine frame coordinate system in a subsequent scanning procedure.

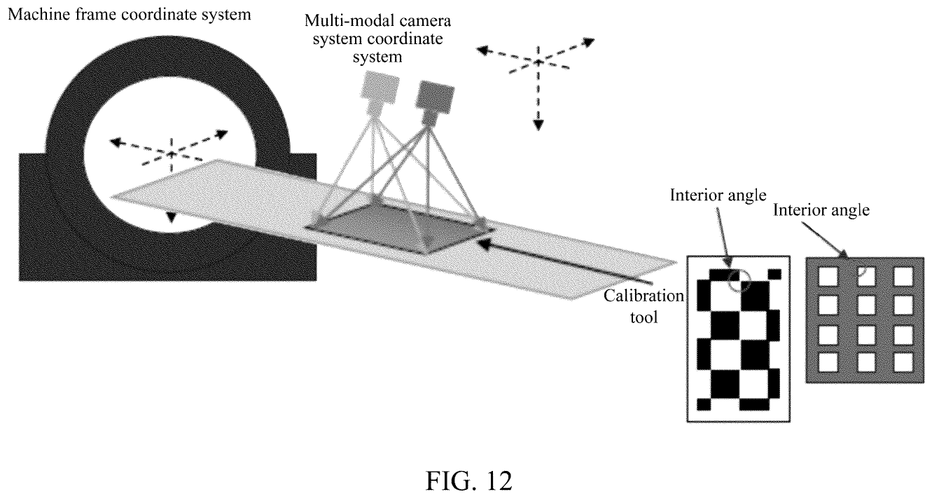

Since the 3D contour of the examination subject acquired in step 160 is based on the thermal image and the depth image, that is, the 3D contour is in a multi-modal camera system coordinate system, the 3D contour needs to be first converted to be in the machine frame coordinate system of the imaging apparatus. The conversion may be implemented via a machine frame-multi-modal camera conversion matrix. How to acquire the machine frame-multi-modal camera conversion matrix will be exemplified below with reference to FIG. 12.

First, a calibration tool may be positioned in the machine frame coordinate system, and for example, the calibration tool may be positioned on the scanning table as shown in FIG. 12, so that the calibration tool is located in a field of view of the multi-modal camera system.

Since the conversion matrix between the respective camera coordinate systems in the multi-modal camera system may be acquired as described above, it is in fact only necessary to position the calibration tool in the field of view of one of the cameras in the multi-modal camera system. The camera may be regarded as a calibration camera, and after a conversion matrix between a coordinate system of the calibration camera and the machine frame coordinate system is acquired, coordinate conversion between the machine frame coordinate system and the other camera coordinate systems may be implemented via the conversion matrix between the other camera coordinate systems and the calibration camera coordinate system.

The multi-modal camera system in FIG. 12 includes a depth camera and a thermal camera, either of which may be selected as the calibration camera. Certainly, the multi-modal camera system may further include an RGB camera, and the RGB camera may also be selected as the calibration camera. When the depth camera or the RBG camera is selected as the calibration camera, the calibration tool may be the chessboard-like calibration tool or the calibration tool with holes. When the thermal camera is selected as the calibration camera, the calibration tool with holes needs to be used.

After the calibration tool is positioned, the calibration tool may be imaged via the calibration camera, and calibration camera interior angle coordinates of an interior angle on the calibration tool in the coordinate system of the calibration camera may be calculated.

Next, machine frame interior angle coordinates of the interior angle on the calibration tool in the machine frame coordinate system may be measured by means of a laser beam emitted by a laser light in the machine frame coordinate system and a distance of movement of the scanning table.

Finally, a rotation matrix R, a translation matrix T, and a scaling matrix S between the multi-modal camera coordinate system and the machine frame coordinate system may be calculated based on the calibration camera interior angle coordinates (i.e., multi-modal camera interior angle coordinates) and the machine frame interior angle coordinates.

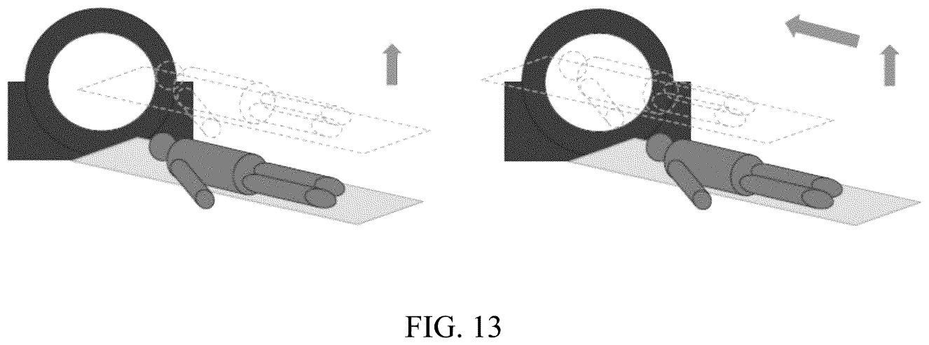

Returning to sub-step 1820, after the 3D contour of the examination subject acquired in step 160 is converted to be in the machine frame coordinate system via the rotation matrix R, the translation matrix T, and the scaling matrix S, the 3D contour coordinate values of the examination subject moving to each position during scanning may be further acquired based on motion offset coordinate values of the scanning table and the 3D contour of the examination subject in the machine frame coordinate system. The examination subject is located on the scanning table, so that a motion offset trajectory of the scanning table corresponds to a motion offset trajectory of the examination subject. FIG. 13 shows a path on which the examination subject moves along with the scanning table during scanning. The motion offset trajectory of the scanning table is known. For example, if the imaging apparatus is a CT machine, a motion offset trajectory of the scanning table thereof and corresponding coordinate values may be acquired directly from a CT scanning system. Thus, the 3D contour coordinate values of the examination subject moving to each position during scanning may be acquired based on the 3D contour of the examination subject and the motion offset coordinate values of the scanning table that are both in the machine frame coordinate system.

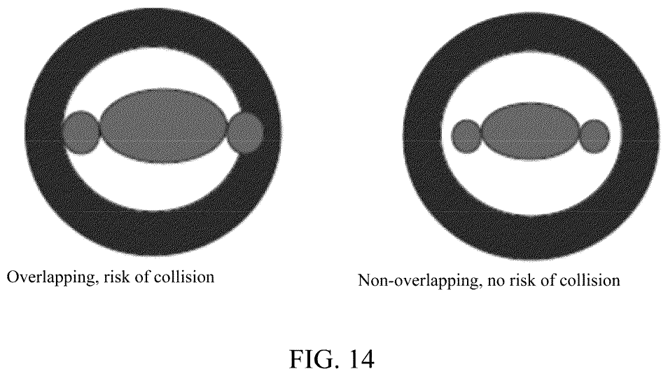

Next, in sub-step 1840, when the 3D contour coordinate values overlap with coordinate values of a machine frame hole of the imaging apparatus, it may be determined that the examination subject will collide, on the movement path thereof, with the machine frame hole. Likewise, the coordinate values of the machine frame hole of the imaging apparatus are also known. For example, if the imaging apparatus is a CT machine, the coordinate values of the machine frame hole thereof may be directly acquired from a CT scanning system. FIG. 14 shows a case in which the 3D contour coordinate values overlap with the coordinate values of the machine frame hole and a case in which the 3D contour coordinate values do not overlap with the coordinate values of the machine frame hole.

So far, the method for predicting a collision between an examination subject and an imaging apparatus according to the present invention is described, a 2D contour of an examination subject is innovatively acquired based on a thermal image of the examination subject, and depth information of the examination subject is further introduced, so that collision prediction is performed based on a 3D contour of the examination subject, thereby providing a more accurate and efficient collision prediction, and greatly improving safety of imaging performed by the imaging apparatus on the examination subject while ensuring efficiency.

According to an embodiment of the present invention, also provided is a computer-readable storage medium, having coded instructions recorded thereon, wherein when the instructions are executed, the method for predicting a collision between an examination subject and an imaging apparatus according to the present invention described above can be implemented. The computer-readable storage medium may include a hard disk drive, a floppy disk drive, a CD-read/write (CD-R/W) drive, a digital versatile disc (DVD) drive, a flash drive and/or a solid-state storage device.

According to an embodiment of the present invention, also provided correspondingly is an imaging apparatus.

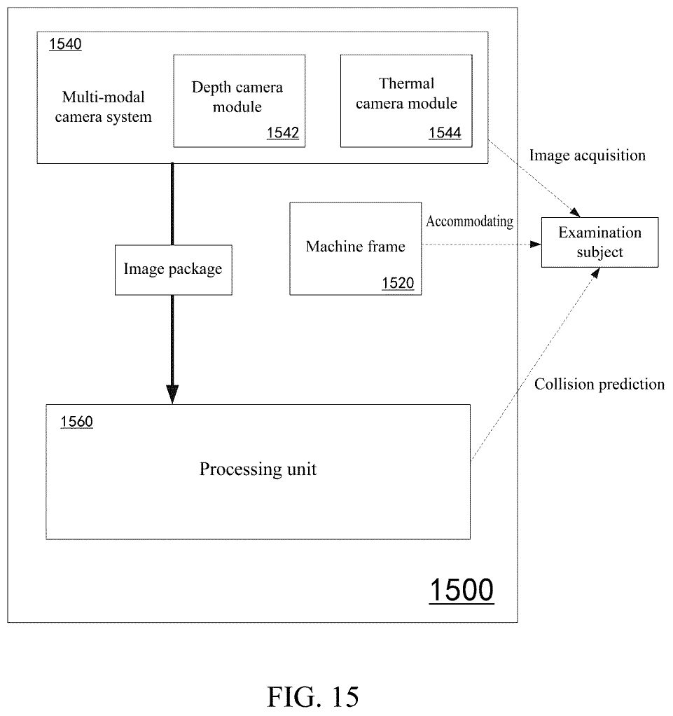

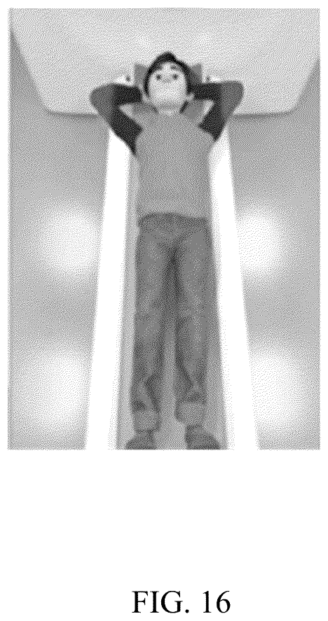

Referring to FIG. 15, FIG. 15 shows an imaging apparatus 1500 according to the present invention. The imaging apparatus 1500 includes a machine frame 1520, a multi-modal camera system 1540, and a processing unit 1560.

The machine frame 1520 may include a machine frame hole for accommodating an examination subject.

The multi-modal camera system 1540 may include a depth camera module 1542 and a thermal camera module 1544. The multi-modal camera system 1540 may be configured to acquire an image package of the examination subject, and the image package includes a depth image and a thermal image of the examination subject.

The processing unit 1560 may be configured to acquire a 2D contour of the examination subject based on segmentation processing performed on the thermal image, generate a 3D contour of the examination subject based on the 2D contour of the examination subject and the depth image of the examination subject, and estimate, based on the 3D contour of the examination subject, whether the examination subject will collide, on a movement path thereof, with an imaging apparatus scanning the examination subject.

Optionally, the processing unit 1560 may be further configured to perform the segmentation processing on the thermal image based on a plurality of predetermined temperature thresholds to acquire a plurality of thermal contour images, and extract the 2D contour of the examination subject from a thermal contour image most conforming to a contour of the examination subject among the plurality of thermal contour images.

Optionally, the multi-modal camera system 1540 may acquire the image package of the examination subject in real time, wherein the processing unit 1560 may be further configured to: perform segmentation processing on a current thermal image based on a preselected temperature threshold to acquire a thermal contour image; and extract the 2D contour of the examination subject from the thermal contour image.

Optionally, the processing unit 1560 may be further configured to perform, based on a plurality of predetermined temperature thresholds, segmentation processing on a thermal image acquired at a certain previous time to acquire a plurality of thermal contour images, and select, from the plurality of thermal contour images, a thermal contour image most conforming to a contour of the examination subject, and determine a temperature threshold corresponding thereto to be the preselected temperature threshold.

Optionally, the thermal contour image most conforming to the contour of the examination subject may selected via comparison with an a priori template image acquired in advance, wherein the processing unit 1560 may be further configured to acquire in advance a plurality of thermal images of different examination subjects under different conditions, perform segmentation processing on each of the plurality of thermal images separately based on a plurality of predetermined temperature thresholds to acquire a plurality of a priori thermal contour images, and select, from the plurality of a priori thermal contour images, an optimal thermal contour image most conforming to a contour of the examination subject, and extract features from all the optimal thermal contour images corresponding to the plurality of thermal images, and create the a priori template image based on the extracted features.

Optionally, the processing unit 1560 may be further configured to acquire the thermal contour image most conforming to the contour of the examination subject by comparing features in the plurality of thermal contour images with features in the a priori template image.

Optionally, the processing unit 1560 may be further configured to calculate 3D coordinate values of each point on the examination subject based on depth information in the depth image and pixel distance information in the 2D contour, and acquire the 3D contour based on all the 3D coordinate values.

Optionally, the depth information may include a perpendicular depth from each point on the examination subject to a focal point of the depth camera module 1542 or the thermal camera module 1544, and the pixel distance information includes a pixel distance from each pixel in the 2D contour to the focal point of the depth camera module 1542 or the thermal camera module 1544, wherein the pixels in the 2D contour correspond to the points on the examination subject.

Optionally, the processing unit 1560 may be further configured to convert the thermal image or the 2D contour to be in a depth camera coordinate system, or convert the depth image to be in a thermal camera coordinate system.

Optionally, the processing unit 1560 may be further configured to calculate 3D contour coordinate values of the 3D contour of the examination subject in a machine frame coordinate system of the imaging apparatus 1500, the 3D contour coordinate values including 3D contour coordinate values of the examination subject moving to each position during scanning, and when the 3D contour coordinate values overlap with coordinate values of a machine frame hole of the imaging apparatus 1500, determine that the examination subject will collide, on the movement path thereof, with the machine frame hole.

The above imaging apparatus can implement the above method for predicting a collision between an examination subject and an imaging apparatus according to the present invention. The above many design concepts and details applicable to the prediction method of the present invention are also applicable to the above imaging apparatus, and the same advantageous technical effects can be achieved, so that the detailed description thereof is omitted here.

Various aspects of the present invention have been described above via some exemplary embodiments. However, it should be understood that various modifications can be made to the exemplary embodiments described above without departing from the spirit and scope of the present invention. For example, an appropriate result can be achieved if the described techniques are performed in a different order and/or if the components of the described system, architecture, apparatus, or circuit are combined in other manners and/or replaced or supplemented with additional components or equivalents thereof; accordingly, the modified other embodiments also fall within the protection scope of the claims.

1. A method for predicting a collision between an examination subject and an imaging apparatus, comprising:
acquiring an image package of the examination subject via a multi-modal camera system, the image package including a depth image and a thermal image of the examination subject, and the multi-modal camera system including a depth camera module and a thermal camera module;
acquiring a 2D contour of the examination subject based on of segmentation processing performed on the thermal image;
generating a 3D contour of the examination subject based on the 2D contour of the examination subject and the depth image of the examination subject; and
estimating, based on the 3D contour of the examination subject, whether the examination subject will collide, on a movement path thereof, with an imaging apparatus scanning the examination subject.

2. The method according to claim 1, wherein acquiring a 2D contour of the examination subject includes:
performing the segmentation processing on the thermal image based on a plurality of predetermined temperature thresholds to acquire a plurality of thermal contour images; and
extracting the 2D contour of the examination subject from a thermal contour image most conforming to a contour of the examination subject among the plurality of thermal contour images.

3. The method according to claim 1, wherein the image package of the examination subject is acquired via the multi-modal camera system in real time, wherein acquiring a 2D contour of the examination subject includes:
performing segmentation processing on a current thermal image based on a preselected temperature threshold to acquire a thermal contour image; and
extracting the 2D contour of the examination subject from the thermal contour image.

4. The method according to claim 3, wherein the preselected temperature threshold is acquired via the following steps:
performing, based on a plurality of predetermined temperature thresholds, segmentation processing on a thermal image acquired at a certain previous time to acquire a plurality of thermal contour images; and
selecting, from the plurality of thermal contour images, a thermal contour image most conforming to a contour of the examination subject, and determining a temperature threshold corresponding thereto to be the preselected temperature threshold.

5. The method according to claim 2 wherein the thermal contour image most conforming to the contour of the examination subject is selected via comparison with an a priori template image acquired in advance, wherein the a priori template image is acquired via the following steps:
acquiring in advance a plurality of thermal images of different examination subjects under different conditions;
performing segmentation processing on each of the plurality of thermal images separately based on a plurality of predetermined temperature thresholds to acquire a plurality of a priori thermal contour images, and selecting, from the plurality of a priori thermal contour images, an optimal thermal contour image most conforming to a contour of the examination subject; and
extracting features from all the optimal thermal contour images corresponding to the plurality of thermal images, and creating the a priori template image based on the extracted features.

6. The method according to claim 5, wherein the thermal contour image most conforming to the contour of the examination subject is acquired by comparing features in the plurality of thermal contour images with features in the a priori template image.

7. The method according to claim 1, wherein generating a 3D contour of the examination includes:
calculating 3D coordinate values of each point on the examination subject based on depth information in the depth image and pixel distance information in the 2D contour, and acquiring the 3D contour based on all the 3D coordinate values.

8. The method according to claim 7, wherein the depth information includes a perpendicular depth from each point on the examination subject to a focal point of the depth camera module or the thermal camera module, and the pixel distance information includes a pixel distance from each pixel in the 2D contour to the focal point of the depth camera module or the thermal camera module, wherein the pixels in the 2D contour correspond to the points on the examination subject.

9. The method according to claim 7, wherein generating a 3D contour of the examination includes the thermal image or the 2D contour being converted to be in a depth camera coordinate system, or the depth image being converted to be in a thermal camera coordinate system.

10. The method according to claim 9, wherein when generating a 3D contour of the examination, via a thermal image conversion matrix, the thermal image or the 2D contour is converted to be in the depth camera coordinate system, or the depth image is converted to be in the thermal camera coordinate system, wherein the thermal image conversion matrix is acquired via the following steps:
positioning a calibration tool so that the calibration tool is in both a field of view of a depth camera and a field of view of a thermal camera;
imaging the calibration tool via the depth camera and the thermal camera respectively, and calculating depth image interior angle coordinate values of an interior angle on the calibration tool in the depth camera coordinate system and thermal image interior angle coordinate values of the interior angle on the calibration tool in the thermal camera coordinate system, wherein the calibration tool is heated to generate a thermal difference from an original temperature thereof; and
calculating the thermal image conversion matrix based on the depth image interior angle coordinate values and the thermal image interior angle coordinate values.

11. The method according to claim 1, wherein estimating, based on the 3D contour of the examination subject includes:
calculating 3D contour coordinate values of the 3D contour of the examination subject in a machine frame coordinate system of the imaging apparatus, the 3D contour coordinate values including 3D contour coordinate values of the examination subject moving to each position during scanning; and
when the 3D contour coordinate values overlap with coordinate values of a machine frame hole of the imaging apparatus, determining that the examination subject will collide, on the movement path thereof, with the machine frame hole.

12. An imaging apparatus, comprising:
a machine frame, including a machine frame hole for accommodating an examination subject;
a multi-modal camera system, including a depth camera module and a thermal camera module, the multi-modal camera system being configured to acquire an image package of the examination subject, the image package including a depth image and a thermal image of the examination subject, and the multi-modal camera system including a depth camera module and a thermal camera module; and
a processing unit, configured to:
acquire a 2D contour of the examination subject based on segmentation processing performed on the thermal image;
generate a 3D contour of the examination subject based on the 2D contour of the examination subject and the depth image of the examination subject; and
estimate, based on the 3D contour of the examination subject, whether the examination subject will collide, on a movement path thereof, with an imaging apparatus scanning the examination subject.

13. The imaging apparatus according to claim 12, wherein the processing unit is further configured to:
perform the segmentation processing on the thermal image based on a plurality of predetermined temperature thresholds to acquire a plurality of thermal contour images; and
extract the 2D contour of the examination subject from a thermal contour image most conforming to a contour of the examination subject among the plurality of thermal contour images.

14. The imaging apparatus according to claim 12, wherein the multi-modal camera system acquires the image package of the examination subject in real time, wherein the processing unit is further configured to:
perform segmentation processing on a current thermal image based on a preselected temperature threshold to acquire a thermal contour image; and
extract the 2D contour of the examination subject from the thermal contour image.

15. The imaging apparatus according to claim 14, wherein the processing unit is further configured to:
perform, based on a plurality of predetermined temperature thresholds, segmentation processing on a thermal image acquired at a certain previous time to acquire a plurality of thermal contour images; and
select, from the plurality of thermal contour images, a thermal contour image most conforming to a contour of the examination subject, and determine a temperature threshold corresponding thereto to be the preselected temperature threshold.

16. The imaging apparatus according to claim 13, wherein the thermal contour image most conforming to the contour of the examination subject is selected via comparison with an a priori template image acquired in advance, wherein the processing unit is further configured to:
acquire in advance a plurality of thermal images of different examination subjects under different conditions;
perform segmentation processing on each of the plurality of thermal images separately based on a plurality of predetermined temperature thresholds to acquire a plurality of a priori thermal contour images, and select, from the plurality of a priori thermal contour images, an optimal thermal contour image most conforming to a contour of the examination subject; and
extract features from all the optimal thermal contour images corresponding to the plurality of thermal images, and create the a priori template image based on the extracted features.

17. The imaging apparatus according to claim 16, wherein the processing unit is further configured to:
acquire the thermal contour image most conforming to the contour of the examination subject by comparing features in the plurality of thermal contour images with features in the a priori template image.

18. The imaging apparatus according to claim 12, wherein the processing unit is further configured to:
calculate 3D coordinate values of each point on the examination subject based on depth information in the depth image and pixel distance information in the 2D contour, and acquire the 3D contour based on all the 3D coordinate values.

19. The imaging apparatus according to claim 12, wherein the processing unit is further configured to:
calculate 3D contour coordinate values of the 3D contour of the examination subject in a machine frame coordinate system of the imaging apparatus, the 3D contour coordinate values including 3D contour coordinate values of the examination subject moving to each position during scanning; and
when the 3D contour coordinate values overlap with coordinate values of a machine frame hole of the imaging apparatus, determine that the examination subject will collide, on the movement path thereof, with the machine frame hole.
